(19) United States
(12) Patent Application Publication
(10) Pub. No.: US 2017/0106805 A1
(43) Pub. Date: Apr. 20, 2017

(54) Uber Safe

(71) Applicant: Richard Wayne Davis, Lynwood, IL (US)

(72) Inventor: Richard Wayne Davis, Lynwood, IL (US)

(21) Appl. No.: 14/822,375

(22) Filed: Oct. 20, 2015

(51) Int. Cl. B60R 11/02; B60N 3/10

(52) U.S. Cl. CPC B60R 11/0235; B60N 3/10

(57) ABSTRACT

UberSafe Partitions are transparent portable removable vehicle partitions with cup holders & LCD monitors manufacture from a clear polycarbonate. The partition acts as a barrier between the driver and passenger unobtrusively ensuring a comfortable environment for both the driver and passengers.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### THE NAMES OF THE PARTIES TO A JOINT RESEARCH AGREEMENT

(Not Applicable)

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

(Not Applicable)

### STATEMENT REGARDING PRIOR DISCLOSURES BY THE INVENTOR OR A JOINT INVENTOR

(Not Applicable)

### BACKGROUND OF THE INVENTION

Created out of a desire of a father to protect his daughters who were earning extra money by driving Uber. This portable, removable security partition would protect his daughters when he couldn't be with them.

(1) Field of the Invention.

Safety

(2) Description of Related Art Including Information Disclosed Under 37 CFR 1.97 and 1.98.

(Not Applicable)

### BRIEF SUMMARY OF THE INVENTION

UberSafe Partitions offer many advantages, but the most important one is peace of mind. They are a sensible and practical way to protect Uber's most valuable assets: their drivers & passengers—nothing else compares.

### BRIEF DESCRIPTION OF THE SEVERAL VIEWS OF THE DRAWING(S)

FIG. 1a—Elevated rear view

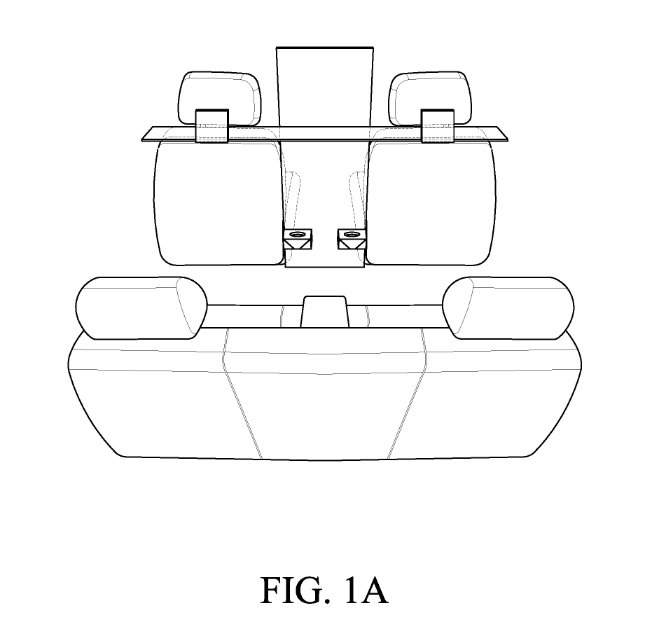

FIG. 1b—Elevated front view

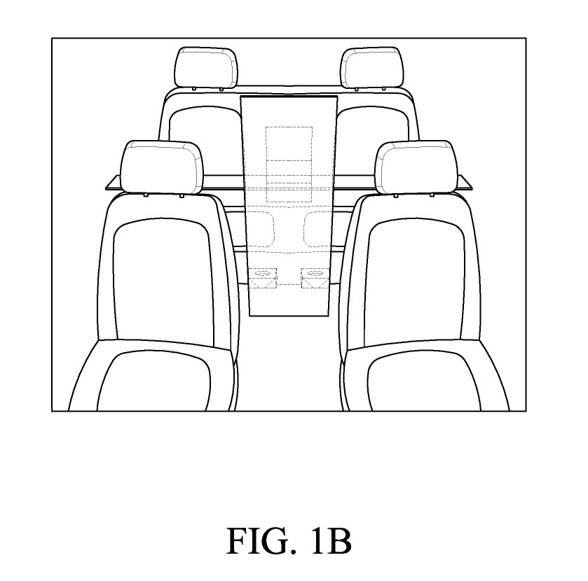

FIG. 1c—Elevated passenger-side view

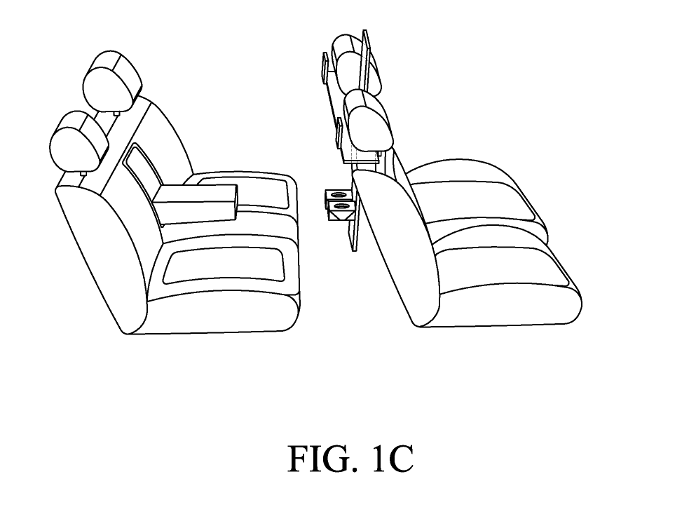

FIG. 1d—Elevated driver-side view

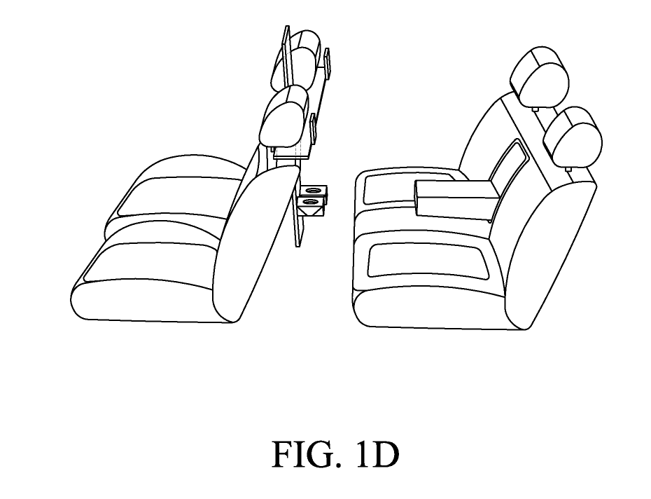

FIG. 2a—Elevated rear view (no seats)

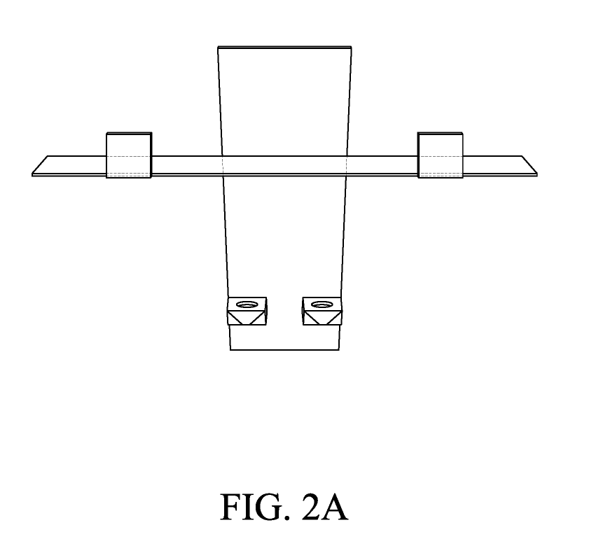

FIG. 2b—Elevated front view (no seats)

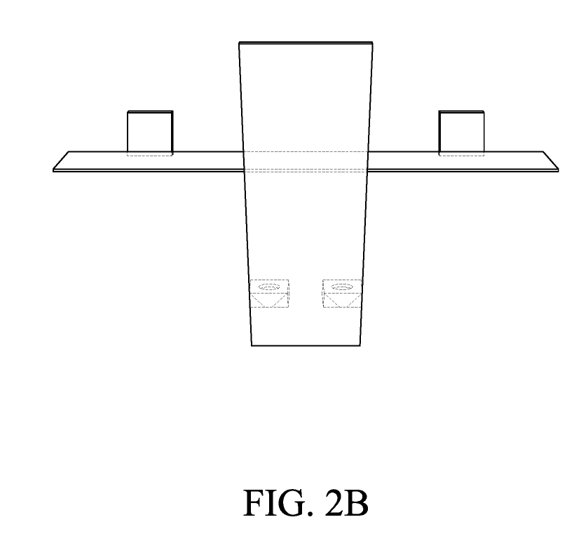

### DETAILED DESCRIPTION OF THE INVENTION

The Uber Safe™ portable Plexiglas automobile partition is designed to be attached to both driver & passenger car seats via the head rests.

Holes drilled into the Uber Safe™ at designated intervals allow the Uber Safe™ to be attached to many different makes & models of automobiles.

The holes on the left side of the Uber Safe™ correspond to the holes in the driver side seat head rest.

The right side of the Uber Safe™ has an oval slit, allowing for variances in car seats differing widths while still maintaining a secure fit regardless of how far apart the car seats are fitted.

The seats do have to be parallel to each other to ensure the Uber Safe™ is level & the driver is secure with no obvious gaps.

Behind each head rest is a TV monitor to display in-car entertainment & advertising, as well as trip information & an updating arrival time.

Each monitor is secured to the Uber Safe™ & is padded for the safety of the passenger should an accident occur.

Cup holders can be optionally installed near the bottom of the middle section for the convenience of the passengers.

Cup holders do not come with the standard Uber Safe™ but can be requested during order.

The Uber Safe™ is made of clear Plexiglas allowing for full visibility of the driver & passenger.

The Uber Safe™ is fitted horizontally to the tops of the front vehicle seats, extending across from side to side, in the middle, in between the seats a vehicle partition extends from the top of the car ceiling to the floor of the inner cabin.

The optical properties of Uber Safe™ are made in accordance with ASTM standard test method E903.

The amount of heat conducted through Uber Safe® glazing is slightly lower than for glass of the same thickness based on the established properties of the Plexiglas material.

Uber Safe® meets the requirements of ANSI Z97.1 at thicknesses of 0.080″ and greater based on the established properties of the Plexiglas material.

What is claimed is:

1. A portable, removable security partition for use in a vehicle stretching across passenger and driver sides, in-between front and rear seating areas, secured by the headrests, the partition comprising:
a horizontal panel;
a vertical clear Plexiglas panel connected to the horizontal panel;

2. The portable, removable security partition of claim 1, wherein the horizontal panel includes attached LCD monitors for viewing ads or in-vehicle entertainment.

3. The portable, removable security partition of claim 1, wherein the vertical panel includes attached cup holders for the passenger's convenience.
